(19) United States
(12) Patent Application Publication
(10) Pub. No.: US 2007/0084913 A1
(43) Pub. Date: Apr. 19, 2007

(54) Systems and methods for authorizing a transaction for a financial account

(75) Inventor: Eric Stephen Weston, Bingham (GB)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Capital One Financial Corporation

(21) Appl. No.: 11/251,872

(22) Filed: Oct. 18, 2005

(51) Int. Cl. G06K 5/00; G06K 15/00; G06Q 40/00

(52) U.S. Cl. 235/380; 235/383; 705/44

(57) ABSTRACT

A method is disclosed for authorizing a purchase transaction made using a purchasing device associated with a financial account and communicating with a point-of-sale (POS) terminal. In one embodiment, the method may include determining a physical location of the purchasing device during the purchase transaction based on location information provided by the purchasing device. Further, the method includes determining a physical location of the POS terminal during the purchase transaction. Based on the identified locations of the purchasing device and POS terminal, a proximity of the purchasing device to the POS terminal is determined. The method may also include authorizing the purchase transaction based on the determined proximity of the purchasing device to the POS terminal.

### DESCRIPTION OF THE INVENTION

The present invention relates generally to methods and systems for authorizing purchase transactions made using a credit card or other types of purchasing devices. More particularly, the present invention relates to authorizing a purchase transaction based on a determined location of the purchasing device during the transaction.

### BACKGROUND OF THE INVENTION

Credit card products have become so ubiquitous that they have fundamentally changed the manner in which financial transactions and dealings are conducted. Credit card products are most commonly represented by plastic card-like members that are offered and provided to consumers by credit card issuers (such as banks and other financial institutions). With a credit card, an authorized consumer is capable of purchasing services and/or merchandise without an immediate, direct exchange of cash. Instead, the customer incurs debt with each purchase. The customer repays the debt upon receipt of a periodic statement from the issuer. When a credit card purchase is made, the transaction is processed by an authorization system and a credit card clearinghouse, such as the Visa or MasterCard networks.

In addition to credit cards, there are other financial account cards that may function like credit cards, but are associated with a bank account, such as a checking account. Cards of this type are sometimes called check cards or debit cards. Transactions made using a check card or a debit card are cleared directly from a cardholder's bank account. A common type of debit card is the automated teller machine (“ATM”) type card.

Moreover, a consumer may use a computing device, such as a mobile phone, a personal digital assistant (PDA), etc. to perform transactions. Transactions made using these types of device may be charged to a financial account associated with the user of the computing device, such as the user' phone bill, credit card account, or bank account.

Typically, when a consumer uses a payment device, such as a credit card, to purchase goods and services, the transaction is monitored by an authorization system that follows certain security protocols to ensure the consumer is authorized to use the payment device for the purchase transaction. For example, a typical credit card transaction may involve the consumer swiping the card in a reader device positioned at a point-of-sale (POS) terminal. Next, the teller operating the POS may request the consumer's signature, which may be compared to a signature located on the back of the credit card. Alternatively, or additionally, the authorization system may request a personal identification number (PIN) from the consumer. The authorization system may send the PIN to a payment device issuer (e.g., a financial entity managing the credit card account), which subsequently determines whether the consumer is authorized to make the purchase transaction with the credit card based on, for example, the submitted PIN, available balance of the credit card account, etc.

Although conventional authorization systems and procedures provide some level of protection during a purchase transaction, they do not take into account the physical location of the payment device in relation to, for example, the POS terminal that is provided by the purchasing device. Accordingly, it would be beneficial to verify that the purchasing device is physically present at time of transaction when authorizing a transaction.

### SUMMARY OF THE INVENTION

Consistent with embodiments of the present invention, systems and methods are disclosed that provide enhanced payment device authorization processes that consider the physical location of the payment device when authorizing a purchase transaction.

Consistent with one exemplary embodiment of the present invention, a method is provided for authorizing a purchase transaction made using a purchasing device associated with a financial account and communicating with a point-of-sale (POS) terminal. The method may include determining a physical location of the purchasing device during the purchase transaction based on location information provided by the purchasing device. Further, the method includes determining a physical location of the POS terminal during the purchase transaction. Based on the identified locations of the purchasing device and POS terminal, a proximity of the purchasing device to the POS terminal is determined. The method may also include authorizing the purchase transaction based on the determined proximity of the purchasing device to the POS terminal

In another embodiment, a system for authorizing a purchase transaction is disclosed. The system may include a purchasing device associated with a financial account and embedded with a transceiver that provides location information reflecting a geographic location of the purchasing device. The system may further include an authorization system and a location determination unit that receives the location information from the transceiver. Moreover, the system may include a POS terminal that provides an authorization request to the authorization system, the request including data associated with the location information. In certain embodiments, the authorization system authorizes the purchase transaction based on a proximity of the purchasing device to the POS terminal.

Consistent with another exemplary embodiment of the present invention, a system is provided for authorizing a purchase transaction. The system may include a purchasing device associated with a financial account that is used for the purchase transaction. The purchasing device may include a transceiver that provides location information reflecting a geographic location of the purchasing device during the purchase transaction. The system may also include an authorization system that authorizes the purchase transaction based on the location information provided by the transceiver.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention. In the drawings:

FIG. 1 illustrates an exemplary authorization system consistent with certain embodiments of the present invention;

FIG. 2 illustrates an exemplary financial account authorization system consistent with certain embodiments of the present invention;

FIG. 3 illustrates an exemplary flow chart of a purchase transaction at a POS location consistent with certain embodiments of the present invention; and

FIG. 4 illustrates an exemplary flow chart of a financial account authorization process consistent with certain embodiments of the present invention.

### DESCRIPTION OF THE EMBODIMENTS

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. Accordingly, substitutions, additions or modifications may be made to one or more of the components and process steps illustrated in the drawings and disclosed herein. The exemplary methods described herein may be modified by substituting, reordering, removing, or adding steps to the disclosed methods. Accordingly, the following detailed description does not limit the invention. Instead, the proper scope of the invention is defined by the appended claims.

Systems and methods consistent with the present invention may determine the geographic proximity of a purchasing device, such as a credit card, to a POS terminal when determining the authorization of a purchase transaction with the payment device. In certain embodiments, the purchasing device may be a processing device in the form of a card that includes a wireless transmitter, such as a Radio Frequency Identification (RFID) and a geographic positioning system, such as a GPS device. The wireless transmitter may communicate position information to a POS terminal, or other type of computer system, reflecting the geographic position of the payment device. Based on the position information, an authorization system may determine the relative geographic location of the purchasing device to the POS terminal. In certain embodiments, the authorization system may authorize the purchase transaction if it determines the purchasing device is within a predefined vicinity of the POS terminal. Similarly, If the authorization system determines the purchasing device is outside the predefined vicinity, the system may deny the transaction. Further, the authorization system may flag a financial account associated with the purchasing device for potential fraudulent activity.

As used herein, the term “purchasing device” refers to any type of product associated with a financial account and used for making a purchase transaction. For example, a purchasing device may be a credit card, a check card, a debit card, or any other type of card or device associated with a financial account offered by a financial entity, such as a bank, merchant, government entity, etc.

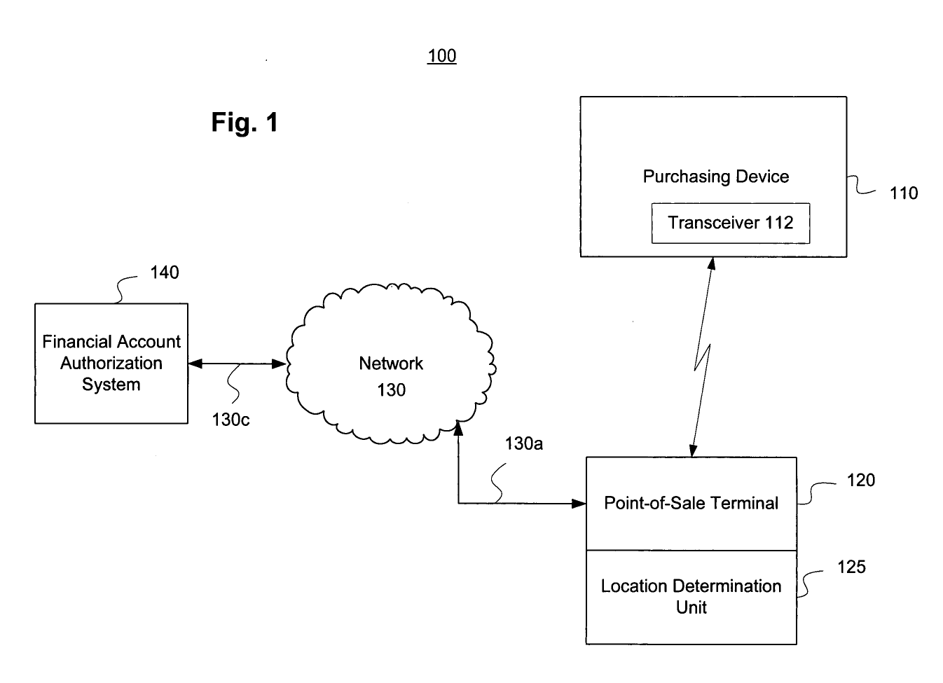

FIG. 1 illustrates an exemplary purchase transaction system 100 consistent with the present invention. As shown in FIG. 1, system 100 may include a purchasing device 110, a POS terminal 120, a network 130, and a financial account authorization system 140.

Purchasing device 110 may have typical features of a financial account card product (e.g., a credit card), such as a magnetic strip containing associated financial account information (e.g., account number, card holder's name, etc.) In one embodiment, purchasing device 110 may also include a transceiver 112 that may be a processing system including one or more processors, one or more memory devices, and/or a wireless transmitter device. Transceiver 112 may either be attached to or embedded into purchasing device 110. Transceiver 112 may be configured to send data from purchasing device 110 to a remote system. In one embodiment, transceiver 112 may transmit a signal indicating the geographic location of purchasing device 110 to a location determination unit 125 positioned with POS terminal 120 For example, transceiver 112 may include a GPS device receives geographic location information from a GPS providing system and service (not shown) remote from purchasing device 110. For example, the GPS device may communicate with a GPS satellite navigation system that is used to determine the precise location of purchasing device 110. The GPS device may decode time signal transmissions received from multiple satellites and to determine the position of purchasing device 110 using, for example, trilateration techniques performed by a processor executing software stored on a memory device within the GPS device. Transceiver 112, therefore, may be a GPS device embedded to calculate and transmit geographic position information associated with purchasing device 110.

In certain embodiments, transceiver 112 may operate as a transceiver that receives and transmits data from purchasing device 110. In this embodiment, transceiver 112 may operate as a transponder that transmits, for example, a wireless signal (e.g., a radio frequency signal) in response to a received query signal provided by another remote system. Depending on the type of technology implemented by certain disclosed embodiments, the range of communications provided by transceiver 112 may vary. For instance, transceiver 112 may include an RFID transceiver that is configured to send and/or receive communication signals from a remote system positioned several inches or feet from purchasing device 110. Accordingly, methods and systems consistent with certain disclosed embodiments are not limited to any type of transmitting or receiving device.

In another embodiment, transceiver 112 may also be activated when purchasing device 110 is reported lost or stolen. For example, the GPS device may be activated by a GPS network controller (not shown) to broadcast geographic position of purchasing device 110 to a remote system, such as POS terminal 120 or a remote security monitoring system. In one example, transceiver 112 may send the geographic position information to a system monitored by authorities, the financial account provider, or any other type of entity, to assist these entities in locating the physical location of purchasing device 110.

POS terminal 120 may be any type of computer system or terminal that performs a purchase transaction. POS terminal 120 may include any components used to process information associated with a purchase transaction. For example, POS terminal 120 may be a credit card reader (e.g., wireless reader, magnetic strip reader, etc.), a telephone, cellular phone, a computer system (e.g., laptop, desktop, mainframe, etc.), a wireless input device, a PDA, or any other type of device that may receive data associated with a purchase transaction and transmit information to a financial account authorization system, such as authorization system 140.

In certain embodiments, POS terminal 120 may include components that determine the geographic location of POS terminal 120. Further, POS terminal 120 may include components that send a signal to activate transceiver 112, thus directing transceiver 112 to send geographic position information associated with purchasing device 110. POS terminal 120 may also send transaction information to authorization system 140 through network 130. POS terminal 120 may be located at a merchant location where a customer holding purchasing device 110 may physically enter and purchase goods and services. Alternatively, POS terminal 120 may be located remote from a merchant location. For example, in embodiments where purchasing device 110 is used to perform on-line purchase transactions over the Internet, POS terminal 120 may be a computer system used by a customer to perform the on-line purchase transaction.

In one embodiment, POS terminal 120 may include, or be connected to, a location determination unit 125 that includes software and/or hardware to determine the location of purchasing entity 110 and/or POS terminal 120. In one embodiment, location determination unit 125 may include a reader device that retrieves geographic location information from transceiver 112. Location determination unit 125 may also include a processor executing software stored on a memory device that calculates the position of purchasing device 110. For example, in certain embodiments, location determination unit 125 may include processing and communication components that send one or more signals to transceiver 112. Based on a response signal provided by transceiver 112, location determination unit 125 may calculate the relative distance between POS terminal 120 and purchasing entity 110. For instance, location determination unit 120 may determine the relative distance based on the amount of time it takes to receive the response signal from transceiver 112. Alternatively, location determination unit may determine the geographic position of purchasing device 110 based on information provided by purchasing device 110 through transceiver 112. Further, location determination unit 125 may be configured with software and/or hardware components that receive geographic location information from transceiver 112 and sends the location information to authorization system 140 over network 130 via POS terminal 120.

In one embodiment, location determination unit 125 may be configured to send an activation signal to transceiver 112 when purchasing device 110 is positioned within the communication range of a transmitting device implemented by location determination unit 125. For example, a consumer carrying purchasing device 110 may walk within an electromagnetic zone of an RFID reader of location determination unit 125 when making a purchase transaction at POS terminal 120. The RFID reader may emit activation signals that are received by transceiver 112. In response to the activation signals, transceiver 112 may be activated, retrieve information from a memory device stored on transceiver 112 and./or purchasing device 110, and provide that information to location determination unit 125. POS terminal 120 may receive the information from location determination unit 125 and sends a request for authorizing the transaction used with purchasing device 110. In one embodiment, location determination unit 125 and/or POS terminal 120 may process the information from transceiver 112 to determine whether purchasing device 110 is within a predetermined vicinity of POS terminal 120. A verification of whether or not purchasing device 110 is within the predetermined vicinity may be included in the request for authorization sent to authorization system 140.

In another embodiment where an exemplary transceiver 112 includes a GPS device, location determination unit 125 may be located anywhere in a communication range of transceiver 112. Transceiver 112 may send location determination unit 125 time signal readings collected from multiple GPS satellites or similar devices. Location determination unit 125 may be configured to process the GPS information to determine the location of purchasing device 110 and determine whether device 110 is within the predetermined vicinity. Alternatively, location determination unit 125 and/or POS terminal 120 may send the GPS information to authorization system 140, which in turn may determine the location of purchasing device 110. Thus, location determination unit 125 may be connected to financial account authorization system 140 via network 130.

Network 130 may include, alone or in any suitable combination, a telephony-based network, a local area network (LAN), a wide area network (WAN), a dedicated intranet, wireless LAN, the Internet, a wireless network, a bus, or any other communication mechanisms. Further, any suitable combination of wired and/or wireless components and systems may be used to provide network connections 130a-130c to POS terminal 120, location determination unit 125, and authorization system 140, respectively. Moreover, network connections 130a-130c may be embodied using bidirectional or unidirectional communication links. Further, network connections 130a-130c may include Web-based protocols, such as Transmission Control Protocol/Internet Protocol (TCP/IP), Hyper Text Transfer Protocol (HTTP), Simple Object Access Protocol (SOAP), and the like.

Authorization system 140 may be a computing system that includes computer system components that enable system 140 to perform processes consistent with the disclosed embodiments. For example, authorization system 140 may include one or more processing devices, one or more memory devices that store data and executable code used by the processing device(s), input/output devices, network connections devices, and any other type of computing component that enable system 140 to process information and send and receive data to and from network 130. Authorization system 140 may maintain and manage financial account information for purchasing devices provided to holders of these devices. The financial account information may include holder profile information (e.g., name, addresses, telephone numbers, passwords, PINs, etc.), account data (e.g., balances, interest rates, bucket information, etc.), and any other type data associated with a financial account.

For example, as part of a purchase transaction authorization process, system 140 may receive information for determining the location of purchasing device 110 in relation to the location of POS terminal 120 during a purchase transaction. For instance, system 140 may receive information reflecting the locations of POS terminal 120 and purchasing device 110. In exemplary embodiments, information reflecting the location of POS terminal 120 may be received from terminal 120 via network 130 and information reflecting the location of purchasing device 110 may be received from location determination unit 125 via network 130. Alternatively, embodiments may be implemented that enable purchasing device 110 to send location information directly to authorization system 140 over network 130 using intermediate devices, such as transceivers, routers, etc.

Accordingly, in certain embodiments, authorization system 140 may determine the locations of purchasing device 110 and POS terminal 120, and calculate the distance between these devices based on the determined locations. For example, authorization system 140 may convert the formats of location information from the two devices into a common format, such as distance values. If the two locations are within a pre-defined radius (e.g., predetermined authorization vicinity) of each other, authorization system 140 may authorize the transaction. If the physical location of purchasing device 110 is not within the pre-defined radius of POS terminal 120, however, authorization system 140 may flag the financial account for potential fraudulent activity, or temporarily disable the account associated with purchasing device 110. The radius used by financial account authorization system 140 may be defined by the financial account provider associated with authorization system 140 and/or purchasing device 110. Alternatively, a holder associated with the financial account for purchasing device 110 may define the radius. For example, the holder may access a Web page provided by the financial account provider to define an authorized radius, send the defined radius value via e-mail, or using any other communication mechanism to send the information to the financial account provider and/or authorization system 140. Authorization system 140 may define the authorized radius based on, for example, holder profile information (e.g., employment data, criminal record information, address data, credit history, etc.) and profile data associated with POS terminal 120 (e.g., address data, transaction histories for a particular merchant, criminal historical data (such as past thefts), etc.). Thus, embodiments of the present invention enable authorization system 140 to define the authorized radius based on data affiliated with a purchasing device holder, POS terminal 120, or other devices or entities associated with a purchase transaction.

In another embodiment, authorization system 140 may maintain in a database data reflecting a predefined authorized IP address (or IP addresses) associated with POS terminal 120. Thus, when a consumer originates a purchase transaction over the Internet using POS terminal 120, authorization system 140 may determine the physical location of POS terminal 120 by checking the current IP address of POS terminal 120 against the predefined authorized IP address(es). For example, a credit card holder may use POS terminal 112 (which may be a laptop, PDA, etc.) may purchase goods from an Internet Web site (e.g., Amazon.com) using purchasing device 110 embedded with transceiver 112. At transaction time, POS terminal 120 may submit purchase transaction information to financial account authorization system 140 over network 130. In response, authorization system 140 may check the current IP address of POS terminal 120 when making the authorization request for the purchase transaction over the Internet.

In another embodiment, authorization system 140 may determine the physical location of POS terminal 120 based on the current IP address. Authorization system 140 may then compare the location of POS terminal 120 with a current location of purchasing device 110 based on received geographic position information provided by, for example, location determination unit 125, or purchasing device 110. As such, authorization system 140 may determine, based on the comparison, whether purchasing device 110 is within a predetermined authorized vicinity of POS terminal 120. Alternatively, authorization system 120 may determine purchasing device 110 is not within the predetermined vicinity of POS terminal 120 if system 140 does not receive any geographic location information for purchasing device 110 during the purchase transaction. This, for example, enables authorization system 140 to handle situations where purchasing device 110 is not located near POS terminal 120 or location determination unit 125 when a consumer is making the purchase transaction.

Authorization system 140 may be configured to accept or deny authorization of a purchase transaction based on the physical proximity of purchasing device 110 with POS terminal 120. Authorization system 140 may also perform additional authorization procedures to verify the use of purchasing device 110 during the purchase transaction. For example, if authorization system 140 determines purchasing device 110 is within a predetermined authorized vicinity of POS terminal 120, authorization system 140 may proceed to authorize the transaction based on other information, such as a consumer's signature or a PIN. On the other hand, if authorization system 140 does not verify the physical proximity of purchasing device 110, authorization system 140 may flag a financial account associated with purchasing device 110 for potential fraudulent activity, temporarily disable the account, and/or any other type of preventive process that prevents purchasing device 110 from being used to complete the purchase transaction.

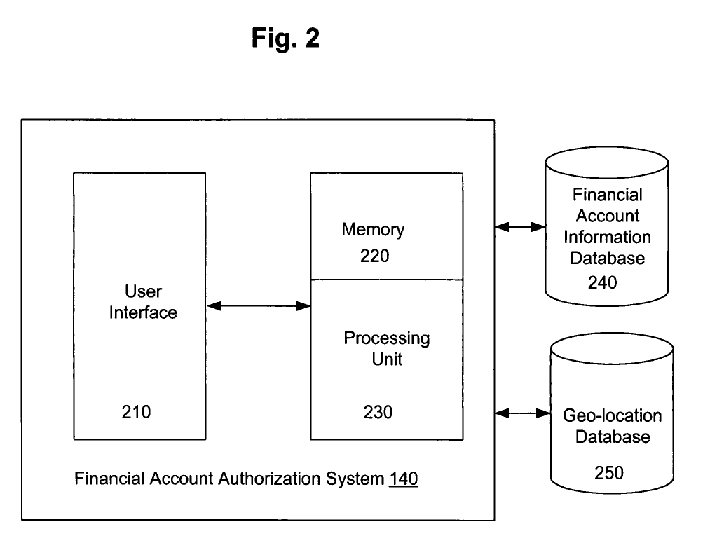

FIG. 2 illustrates an exemplary financial account authorization system 140 consistent with certain disclosed embodiments of the present invention. As shown in FIG. 2, system 140 may include a user interface 210, a memory 220, a processing unit 230, a financial account information database 240, and a geographical location information database 250. Memory 220 may store software that may be executed by processor 230 to perform financial account authorization processes consistent with the present invention. Processing unit 230 may include one or more central processing units (CPU), microprocessors, or other types of processing devices.

Financial account authorization system 140 may be connected to databases 240 and 250 by communication links, such as network links, telephone lines, radio frequency links, or any other data transmission links. Financial account information database 240 may store information related to customers and financial accounts associated with purchasing devices 110. For example, database 240 may contain, an account holder's name, date of birth, social security number, account balance, credit limit, etc. In some embodiments, database 240 may further contain data reflecting an authorized radius (e.g., predetermined authorized vicinity) that purchasing device 110 must be within a particular POS terminal 120 for a transaction to be authorized. Database 140 may maintain an authorization radius for different POS terminals 120 for a single purchasing device 110. Thus, database 140 may store a first POS terminal 120 may have a first authorized radius for purchasing device 110, and a second POS terminal 120 may have a second authorized radius for purchasing device 110. System 140 may use these values to determine the proximity of POS terminal 120 to purchasing device 110. Database 250 may contain geographical location information, which may be used by financial account authorization system 140 to calculate the distance between a POS terminal 120 and purchasing device 110. For example, database 250 may contain location information of a number of POS terminals 120 that are fixed locations. Further, database 250 may include one or more predetermined IP addresses for one or more POS terminals 120.

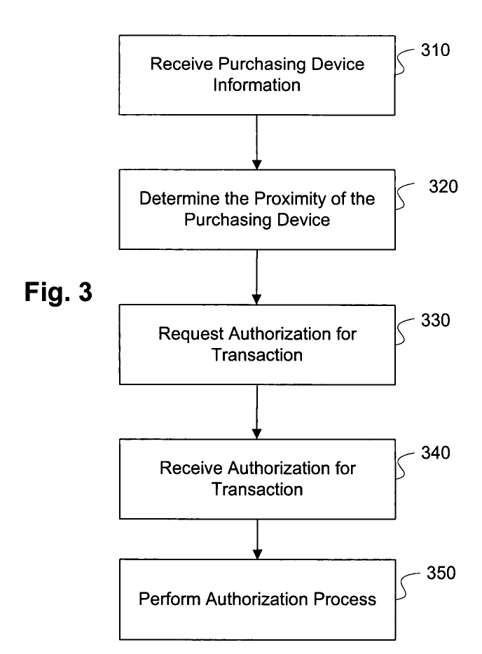

As described, embodiments consistent with the present invention allow a consumer may make a purchase via a POS terminal 120 using purchasing device 110. POS terminal 120 may then send request to financial account authorization system 140 for authorization of the transaction. FIG. 3 illustrates an exemplary flow chart of a POS process consistent with certain embodiments of the present invention. Referring to FIGS. 1 and 3 a consumer may make a purchase by using purchasing device 110. Subsequently, POS terminal 120 may receive identification information from purchasing device 110 (Step 310).

During the purchase transaction, in one embodiment, POS terminal 120 and/or location determination unit 125 may determine the location of purchasing device 110 by retrieving or receiving location information from transceiver 112. POS terminal 120 may determine the proximity of purchasing device 110 to POS terminal 120 based on the location information received by location determination unit 125 (Step 320).

POS terminal 120 may generate a request to authorize the purchase transaction to financial account authorization system 140 (Step 330). In one embodiment, the request may include the location information provided by transceiver 112. Alternatively, the request may include data generated by location determination unit 125 reflecting the physical location of purchasing device 110 based on the location information provided by device 110. Moreover, the request may include data generated by location determination device 125 reflecting a determined vicinity of purchasing device 110 to POS terminal 120. In another embodiment, location determination unit 125 may send authorization system 140 the location information of purchasing device 110. Location determination unit 125 may perform location and/or vicinity determination processes in a manner similar to the processes described above in connection with FIGS. 1 and 2.

Financial account authorization system 140 may receive the authorization request (Step 340). Based on the location information included in the request (either determined vicinity information or location information), authorization system 140 may perform an authorization process to determine whether the purchase transaction is allowed using purchasing device 110 (Step 350). In accordance with certain embodiments, authorization system 140 may determine whether the purchase transaction is authorized based on the proximity of purchasing device 110 to POS terminal 120. Alternatively, authorization system 140 may determine the location of POS terminal 120 based on identification information provided by POS terminal 120. Authorization system 140 may further determine the physical location of purchasing device 110 based on the location information received from location determination unit 125. If authorization system 140 confirms that purchasing device 110 is within the predefined vicinity of terminal 120, system 140 may proceed with additional authorization processes, such as verifying passwords, PINs, signature information, etc. Once authorization system 140 completes its processes, authorization system 140 may provide POS terminal 120 an authorization message associated with the purchase transaction. Thus, if authorization system 140 determines, for example, purchasing device 110 is not physical located within a predetermined proximity to POS terminal 120, authorization system 140 may flag a financial account for potential fraudulent activity and/or deny authorization of the transaction. In this regard, the authorization message may include data reflecting a denial of the authorization request.

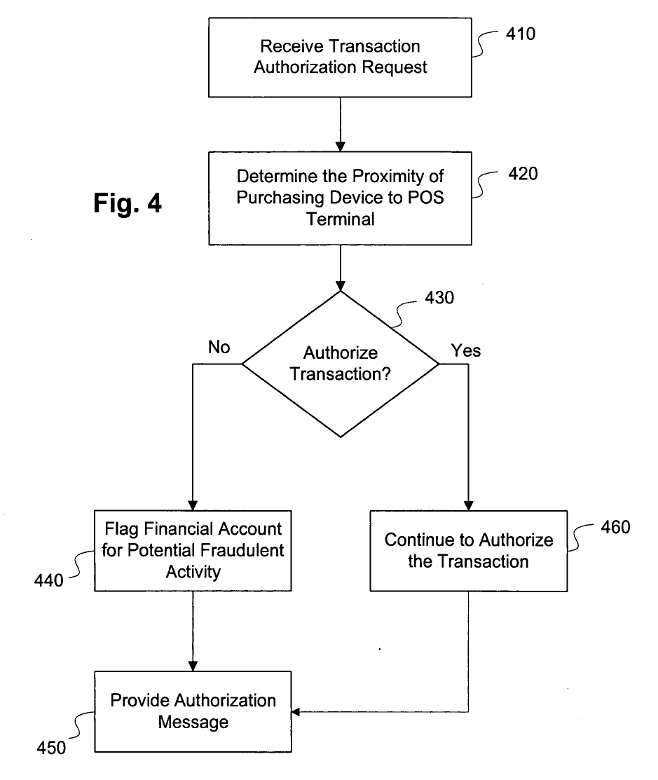

As explained, authorization system 140 performs authorization processes based on the physical location of purchasing device 110. FIG. 4 illustrates an exemplary flow chart of a financial account authorization process consistent with these embodiments of the present invention. Initially, authorization system 140 may receive the authorization request from POS terminal 120 (Step 410). The transaction authorization request may include data reflecting the purchase transaction amount, financial account information, POS terminal 120 identification information, POS terminal 120 location information, and any location information forwarded, processed, or generated by location determination unit 125 that is associated with purchasing device 110.

Based on the received location information, financial account authorization system 140 may determine the physical proximity of purchasing device 110 to the POS terminal 120 (Step 420). In one embodiment, authorization system 140 may determine the proximity by comparing the location of POS terminal 120 with a determined location of purchasing device 110. Authorization system 140 may then compare these locations to determine the proximity of purchasing device 110 to POS terminal 120. In another embodiment, authorization system 140 may analyze the location information provided by location determination unit 125 to ascertain the proximity of purchasing device 110. For instance, if location determination unit 125 previously determined the vicinity of purchasing device 110 (e.g., device 110 is within five feet of POS terminal 120), authorization system 140 may compare the vicinity information to a predetermined authorized range to ascertain whether to authorized the transaction. Other processes may be implemented by authorization system 140 to check the vicinity of purchasing device 110 in relation to POS terminal 120, and the above described examples are not intended to be limiting.

Accordingly, based on the determine proximity of purchasing device 110, authorization system 140 determines whether to authorize the purchase transaction (Step 430). If authorization system 140 determines purchasing device 110 is physically located within an authorized range of POS terminal 120, financial account authorization system 140 may continue to perform additional authorization processes as necessary (Step 460). If the additional authorization processes are verified, authorization system 140 may generate an authorization message in a manner similar to that described above in connection with FIG. 3 (Step 450).

On the other hand, if authorization system 140 determines that purchasing device 110 is not physically located within the authorized range of POS terminal 120 (e.g., purchasing device 110 is outside an authorized radius of terminal 120), authorization system 140 may flag device 110's financial account for potential fraudulent activity (Step 440). Additionally, or alternatively, authorization system 140 may temporarily disable the financial account, thus preventing purchasing device 110 from being used to complete the purchase transaction. Authorization system 140 may further generate the authorization message described above in connection with FIG. 3, and provide the message to POS terminal 120 (Step 450). Further, authorization system 140 may send out requests to contact the account holder to report any potentially fraudulent transactions.

As will be appreciated by those skilled in the art, the authorization processes described in the disclosed embodiments may be implemented instead of, or in addition to, conventional signature/PIN based credit/debit card authorization processes. Depending on business or technical requirements, the authorization processes consistent with certain disclosed embodiments may also be performed before, during, or following conventional signature/PIN based authorization processes.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for authorizing a purchase transaction made using a purchasing device associated with a financial account and communicating with a POS terminal, the method comprising:
determining a physical location of the purchasing device during the purchase transaction based on location information provided by the purchasing device;
determining a physical location of the POS terminal during the purchase transaction;
determining a proximity of the purchasing device to the POS terminal based on the identified locations of the purchasing device and POS terminal; and
authorizing the purchase transaction based on the determined proximity of the purchasing device to the POS terminal.

2. The method of claim 1, wherein determining a location of the purchasing device comprises:
sending location information from a transceiver embedded in the purchasing device to a location determination unit associated with the POS terminal, wherein the location information indicates a geographic location of the purchasing device during the purchase transaction.

3. The method of claim 1, wherein determining a location of the purchasing device comprises:
sending location information from a GPS device embedded in the purchasing device to a location determination unit associated with the POS terminal, wherein the location information indicates a geographic location of the purchasing device during the purchase transaction.

4. The method of claim 1, wherein determining the proximity of the purchasing device to the POS terminal comprises:
calculating a physical distance between the purchasing device and the POS terminal; and
comparing the calculated distance to a predefined authorization radius.

5. The method of 1, wherein determining the location of a POS terminal comprises:
determining a network address of the POS terminal; and
determining the physical location of the POS terminal based on the determined network address.

6. The method of claim 2, further comprising:
providing, from the location determination unit, an activation signal to the transceiver when the transceiver is within a communication range of the location determination unit.

7. The method of claim 2, further comprising:
receiving an indication that the purchasing device is not in possession of an authorized user associated with the financial account; and
providing an activation signal to the transceiver to direct the transceiver to send the location information to the location determination unit.

8. The method of claim 1, wherein determining the proximity of the purchasing device to the POS terminal comprises:
determining, by a location determination unit associated with the POS terminal, the proximity of the purchasing device to the POS terminal; and
providing, by the POS terminal, information reflecting the determined proximity to an authorization system remotely located from the POS terminal.

9. The method of claim 8, wherein authorizing the purchase transaction comprises:
determining, by the authorization system, whether the purchasing device is within an authorized distance of the POS terminal based on the information reflecting the determined proximity of the purchasing device to the POS terminal.

10. The method of claim 4, further comprising:
defining, by a user associated with the financial account, the predefined authorization radius.

11. A system for authorizing a purchase transaction, comprising:
a receiving component communicating with a purchasing device associated with a financial account that is used for the purchase transaction, wherein the receiving component receives, from the purchasing device, location information reflecting a geographic location of the purchasing device during the purchase transaction; and
an authorization system that authorizes the purchase transaction based on the location information received from the purchasing device.

12. The system of claim 11, further including:
a POS terminal that receives financial account information and the location information provided by the purchasing device during the purchase transaction, and sends the financial account and location information in an authorization request to the authorization system.

13. The system of claim 12, wherein the POS terminal includes a location determination unit that receives the location information from the transceiver and determines a proximity of purchasing device to the POS terminal based on the location information.

14. The system of claim 13, wherein the location determination unit provides data reflecting the determined proximity to the POS terminal for submission to the authorization system.

15. The system of claim 14, wherein the authorization system authorizes the purchase transaction based on whether the determined proximity is within a predetermined authorization radius associated with the POS terminal.

16. The system of claim 11, further including:
a POS terminal connected to a network and having a current network address during the purchase transaction,
wherein the authorization system determines the location of the POS terminal based on the current network address and determines whether the purchasing device is within a predetermined authorized range of the POS terminal based on the determined location of the POS terminal and the location information provided by the purchasing device.

17. The system of claim 16, wherein the POS terminal provides the location information of the purchasing device to the authorization system.

18. A system for authorizing a purchase transaction, comprising:
a purchasing device associated with a financial account and embedded with a transceiver that provides location information reflecting a geographic location of the purchasing device;
a authorization system;
a location determination unit that receives the location information from the transceiver; and
a POS terminal that provides an authorization request to the authorization system, the request including data associated with the location information,
wherein the authorization system authorizes the purchase transaction based on a proximity of the purchasing device to the POS terminal.

19. The system of claim 18, wherein the location determination unit further comprises:
a reader device that receives the location information from the transceiver when the purchasing device is positioned within a communication range of the reader device,
wherein the location determination unit determines the proximity of the purchasing device to the POS terminal based on the received location information.

20. The system of claim 18, wherein the authorization system determines the proximity of the purchasing device to the POS terminal at time of transaction based on the location information of the purchasing device and location information of the POS terminal.

21. The system of claim 19, wherein the POS terminal verifies the determined proximity of the purchasing device to the POS terminal.

22. The system of claim 21, wherein the POS terminal sends the verification authorization system in the authorization request.

23. The system of claim 22, wherein the authorization system authorizes the purchase transaction based on the verification received from the POS terminal.
